(19) United States
(12) Patent Application Publication
(10) Pub. No.: US 2011/0208330 A1
(43) Pub. Date: Aug. 25, 2011

(54) SOUND RECORDING DEVICE

(75) Inventors: Hisatoshi OOMAE, Nishinomiya City (JP); Tatsuo KOGA, Daito City (JP); Hideto SHIMAOKA, Uji City (JP)

(73) Assignee: SANYO ELECTRIC CO., LTD., Osaka (JP)

(21) Appl. No.: 13/033,989

(22) Filed: Feb. 24, 2011

(30) Foreign Application Priority Data
Feb. 24, 2010 (JP) 2010-038249
Nov. 29, 2010 (JP) 2010-265309

(51) Int. Cl. G06F 17/00

(52) U.S. Cl. 700/94

(57) ABSTRACT

A sound recording device includes a recording unit which records an input sound signal in a recording medium, a detection unit which detects a specific sound signal corresponding to specific sound output from a predetermined instrument that can be included in the input sound signal, and a control unit which controls an action of the recording unit on the basis of a result of the detection by the detection unit.

### CROSS-REFERENCE TO RELATED APPLICATIONS

This nonprovisional application claims priority under 35 U.S.C. §119(a) on Patent Application No. 2010-38249 filed in Japan on Feb. 24, 2010 and Patent Application No. 2010-265309 filed in Japan on Nov. 29, 2010, the entire contents of which are hereby incorporated by reference.

### BACKGROUND OF THE INVENTION

1. Field of the Invention

The present invention relates to a sound recording device for recording sound signals.

2. Description of Related Art

A sound recording device such as a digital sound recorder is used for recording an interview, recording conversation, recording a meeting, recording a lecture, or recording a music performance, for example.

Among the sound recording devices, one that performs high quality recording in a linear pulse code modulation (PCM) format without compressing data (so-called linear PCM recorder) has become popular. Since the linear PCM recorder can perform high quality recording as described above, it is often used by music-related persons who record a music performance or the like.

When recording a music performance, user's hands are full for the performance in most cases. In addition, when recording practice performance of a band, it is necessary to position the sound recording device at a place apart from players of instruments in order to record the entire performance of the instruments in good balance. In this case, it is necessary that the user moves apart from the instrument so as to place the sound recording device that is set to the recording mode in advance at the place apart from the performance position, and comes back to the performance position so as to start the performance. Further, when the performance is finished, the user has to go to the place where the sound recording device is positioned so as to stop the recording mode of the sound recording device. Therefore, there is an inconvenience that even if the user wants to record only the performance, unnecessary parts before and after the performance are recorded.

Some of the sound recording devices have an automatic recording function in which the sound signal obtained by a microphone or the like is analyzed so that the recording is automatically started when a sound signal level becomes a preset threshold value or higher, and the recording is automatically stopped when the sound signal level becomes lower than a preset threshold value.

However, in a practice performance of a band, conversation among members of the band or tuning of instruments may be made before and after the performance. Therefore, when the above-mentioned automatic recording function is used for recording, there may be the inconvenience that even if it is required to record only the performance, unnecessary parts before and after the performance are also recorded.

There is a conversation recording device that starts recording when it detects a start keyword by speech recognition, and finishes the recording when it detects an end keyword by speech recognition. The conversation recording device has a problem that the device is apt to be a large scale because it is necessary to register the start keyword and the end keyword in dictionary data and to perform always the speech recognition of the sound signal obtained from a microphone or the like.

### SUMMARY OF THE INVENTION

It is an object of the present invention to provide a sound recording device that is suitable for recording music performance.

In order to achieve the object, a sound recording device according to the present invention includes a recording unit which records an input sound signal in a recording medium, a detection unit which detects a specific sound signal corresponding to specific sound output from a predetermined instrument that can be included in the input sound signal, and a control unit which controls an action of the recording unit on the basis of a result of the detection by the detection unit.

Meanings and effects of the present invention will be further clarified by the following description of embodiments. However, the embodiments described below are merely examples of the present invention, and meanings of the present invention and terms of elements are not limited to those described in the following description of the embodiments.

### BRIEF DESCRIPTION OF THE DRAWINGS

FIG. 1 is a block diagram illustrating a structure of a sound recording device according to a first embodiment of the present invention.

FIG. 2 is a flowchart illustrating a recording action of the sound recording device according to the first embodiment of the present invention in the case where a remote control mode based on a specific sound output from a predetermined instrument is set to ON.

FIG. 3 is a diagram illustrating a structural example of a detection unit.

FIG. 4 is a diagram illustrating another structural example of the detection unit.

FIG. 5 is a diagram illustrating still another structural example of the detection unit.

FIG. 6A is a diagram illustrating a display screen example of a display unit.

FIG. 6B is a diagram illustrating a display screen example of a display unit.

FIG. 7 is a diagram illustrating a structural example of a band pass filter unit.

FIG. 8 is a diagram illustrating another structural example of the band pass filter unit.

FIG. 9 is a flowchart illustrating a recording action of a sound recording device according to a second embodiment of the present invention in the case where a remote control mode based on a specific sound output from a predetermined instrument is set to ON.

FIG. 10 is a diagram illustrating an example of a singing voice detection unit.

FIG. 11 is a diagram illustrating a fundamental frequency of singing voice.

FIG. 12A is a diagram illustrating another display screen example of the display unit.

FIG. 12B is a diagram illustrating another display screen example of the display unit.

### DETAILED DESCRIPTION OF THE PREFERRED EMBODIMENTS

Now, embodiments of the present invention are described as follows.

### First Embodiment

<Structure of Device>

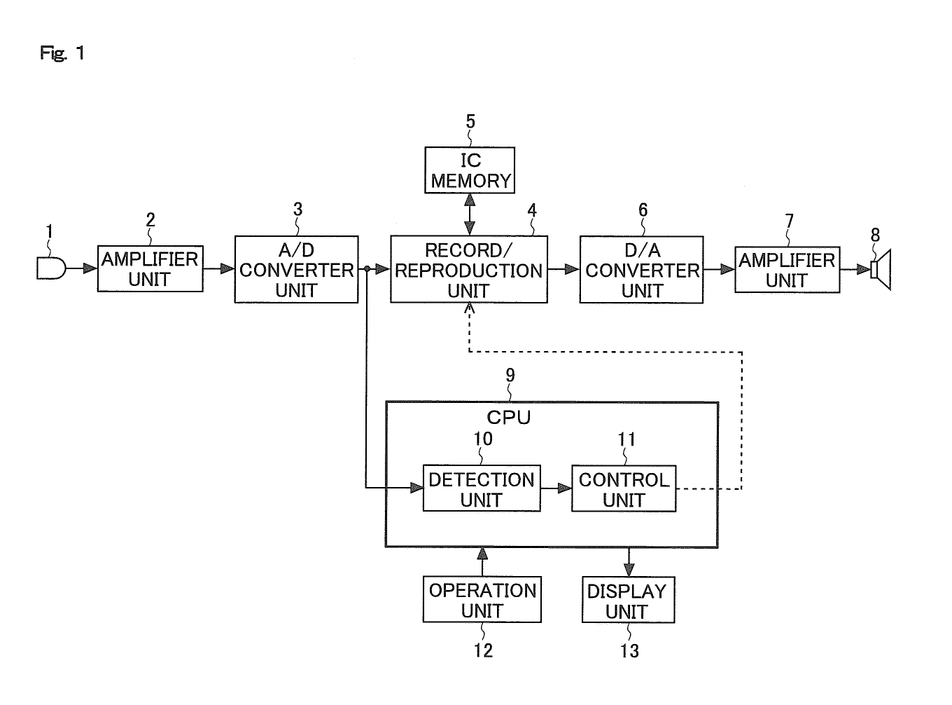

A structure of a sound recording device according to a first embodiment of the present invention is illustrated in FIG. 1. The sound recording device according to the first embodiment of the present invention, which is a digital sound recorder capable of recording in a linear PCM format, includes a microphone 1, an amplifier unit 2, an A/D converter unit 3, a record/reproduction unit 4 (a record/play unit 4), an IC memory 5, a D/A converter unit 6, an amplifier unit 7, a speaker 8, a CPU 9, an operation unit 12, and a display unit 13.

The CPU 9 controls driving actions of the entire sound recording device. In addition, the CPU 9 includes a detection unit 10 that detects a specific sound signal corresponding to a specific sound from a predetermined instrument, and a control unit 11 that controls an action of the record/reproduction unit 4 on the basis of a result of the detection by the detection unit 10.

The microphone 1 converts collected sound into a sound signal that is an electric signal. The amplifier unit 2 amplifies the sound signal output from the microphone 1. The A/D converter unit 3 converts an analog signal output from the amplifier unit 2 into a digital signal. The digital sound signal output from the A/D converter unit 3 is supplied to the record/reproduction unit 4 and the CPU 9.

The record/reproduction unit 4 performs a recording process (sound recording process) and a reproducing process in accordance with an instruction from the CPU 9. When the recording process is performed, the record/reproduction unit 4 records the digital sound signal output from the A/D converter unit 3 in the IC memory 5 without compression if the linear PCM format is used for recording. In contrast, if a format other than the linear PCM format is used for recording, the record/reproduction unit 4 performs a compression coding process on the digital sound signal output from the A/D converter unit 3 and records the compression-coded signal in the IC memory 5. In addition, when the reproducing process is performed, the record/reproduction unit 4 delivers the uncompressed signal read out from the IC memory 5 to the D/A converter unit 6 if the signal recorded in the linear PCM format is reproduced. In contrast, if the signal recorded in a format other than the linear PCM format is reproduced, the record/reproduction unit 4 expands and decodes the compression-coded signal read out from the IC memory 5, and delivers the obtained digital sound signal to the D/A converter unit 6.

The D/A converter unit 6 converts the digital signal output from the record/reproduction unit 4 into an analog signal. The amplifier unit 7 amplifies an analog sound signal output from the D/A converter unit 6. The speaker 8 reproduces and outputs sound on the basis of the analog sound signal amplified by the amplifier unit 7 and output from the same.

The operation unit 12 delivers an operation signal to the CPU 9 in accordance with a user's operation. The CPU 9 performs control and various settings concerning various actions such as the recording action and a reproducing action on the basis of the operation signal output from the operation unit 12.

The display unit 13 displays an action state and various set states in accordance with an instruction from the CPU 9.

<Recording Action>

Next, the recording action of the sound recording device according to the first embodiment of the present invention in the case where a remote control mode based on a specific sound output from a predetermined instrument is set to ON will be described with reference to FIGS. 1 and 2. FIG. 2 is a flowchart illustrating the recording action of the sound recording device according to the first embodiment of the present invention in the case where a remote control mode based on a specific sound output from a predetermined instrument is set to ON. Note that the remote control mode based on a specific sound output from a predetermined instrument may be automatically set to ON when the sound recording device according to the first embodiment of the present invention is powered on by an operation of the user using the operation unit 12, or may be changed from OFF to ON by a predetermined key operation of the user using the operation unit 12, or may be changed from OFF to ON when the sound recording device according to the first embodiment of the present invention detects a sound at a predetermined level or higher, or may be changed from OFF to ON when the detection unit 10 detects a specific sound signal corresponding to a specific sound output from a predetermined instrument (that may be the same as or different from a specific sound signal to be detected in Step S10 described later, and may be the same as or different from a specific sound signal to be detected in Step S30 described later). The detection of a sound at a predetermined level or higher by the sound recording device according to the first embodiment of the present invention can be realized, for example, when the CPU 9 decides whether or not the digital sound signal level output from the A/D converter unit 3 is a preset threshold value or higher.

When the remote control mode based on a specific sound output from a predetermined instrument is set to ON, the detection unit 10 tries first to detect a specific sound signal corresponding to the specific sound output from a predetermined instrument (Step S10).

If the detection unit 10 does not detect a specific sound signal corresponding to the specific sound output from a predetermined instrument (NO in Step S10), the process flow stays on Step S10.

On the contrary, if the detection unit 10 detects specific sound signal corresponding to the specific sound output from a predetermined instrument (YES in Step S10), the control unit 11 instructs the record/reproduction unit 4 to start or restart recording (Step S20), and then the process flow goes to Step S30. Further, it is possible that the control unit 11 instructs the record/reproduction unit 4 promptly to start or restart recording when the detection unit 10 detects the specific sound signal corresponding to the specific sound output from a predetermined instrument. However, in order to avoid that the specific sound signal is recorded at the start or restart of recording, it is desirable that the control unit 11 instructs the record/reproduction unit 4 to start or restart recording a predetermined time (e.g., five seconds) after the detection of the specific sound signal corresponding to the specific sound output from a predetermined instrument by the detection unit 10.

In Step S30, the detection unit 10 tries to detect a specific sound signal corresponding to a specific sound output from a predetermined instrument (Step S30). Note that the specific sound signal to be detected in Step S30 may be the same as or different from the specific sound signal to be detected in Step S10.

If the detection unit 10 does not detect the specific sound signal corresponding to the specific sound output from a predetermined instrument (NO in Step S30), the process flow stays on Step S30. Thus, the recording is continued.

On the contrary, if the detection unit 10 detects the specific sound signal corresponding to the specific sound output from a predetermined instrument (YES in Step S30), the control unit 11 instructs the record/reproduction unit 4 to suspend (pause) the recording (Step S40), and then the process flow goes back to Step S10. Further, when the detection unit 10 detects specific sound signal corresponding to the specific sound output from a predetermined instrument, it is possible to record until the specific sound signal. However, in order to avoid that the specific sound signal is recorded when suspending the recording, it is desirable that the control unit 11 instructs the record/reproduction unit 4 to suspend the recording a predetermined time (e.g., five seconds) before the time point when the specific sound signal is input to the record/reproduction unit 4. In this case, for example, it is preferable to dispose a first-in first-out (FIFO) memory that is a ring buffer capable of storing the sound signal of a predetermined time between the A/D converter unit 3 and the record/reproduction unit 4.

Then, when the remote control mode based on a specific sound output from a predetermined instrument is changed from ON to OFF, the record suspending state is canceled or the recording is promptly stopped, so that the action of the flowchart illustrated in FIG. 2 is finished. Note that the remote control mode based on a specific sound output from a predetermined instrument may be automatically set to OFF when the sound recording device according to the first embodiment of the present invention is powered off by the user's operation using the operation unit 12, or may be changed from ON to OFF by a predetermined key operation of the user using the operation unit 12, or may be changed from ON to OFF when the detection unit 10 detects the specific sound signal corresponding to the specific sound output from a predetermined instrument (that is different from the specific sound signal to be detected in Step S10 and from the specific sound signal to be detected in Step S30).

In addition, if the remote control mode based on a specific sound output from a predetermined instrument is set to ON, it is desirable to inform the user that the remote control mode based on a specific sound output from a predetermined instrument is set to ON. As the informing method, for example, there is a method in which an LED lamp is provided to the sound recording device according to the first embodiment of the present invention, and the LED lamp is turned on when the remote control mode based on a specific sound output from a predetermined instrument is set to ON, while the LED lamp is turned off when the remote control mode based on a specific sound output from a predetermined instrument is set to OFF.

More desirably, when the remote control mode based on a specific sound output from a predetermined instrument is set to ON, it is preferable to inform the user whether or not the recording is being performed. As the informing method, for example, there is a method in which an LED lamp is provided to the sound recording device according to the first embodiment of the present invention, the LED lamp is blinked when the remote control mode based on a specific sound output from a predetermined instrument is set to ON and the recording is being performed, the LED lamp is turned on when the remote control mode based on a specific sound output from a predetermined instrument is set to ON and the recording is not being performed, and the LED lamp is turned off when the remote control mode based on a specific sound output from a predetermined instrument is set to OFF.

With the recording action described above, the user can perform remote control of starting, restarting, and suspending of the recording with a predetermined instrument. Therefore, when recording a practice performance of a band, for example, it is easy to prevent undesirable parts before and after the performance from being recorded, and it is easy to prevent the storage capacity of the IC memory 5 from being consumed wastefully so that a utilization ratio of the IC memory 5 can be improved.

When a remote control transmitter is used for the remote control, it is necessary to hold the remote control transmitter in hand. Therefore, it is difficult to transfer smoothly from the remote control using the remote control transmitter to playing of the instrument, or to transfer smoothly from playing of the instrument to the remote control using the remote control transmitter. In contrast, with the sound recording device according to the first embodiment of the present invention, it is possible to perform the remote control using the predetermined instrument. Therefore, there is a merit that it is possible to transfer smoothly from the remote control to the playing of the instrument, or to transfer smoothly from playing of the instrument to the remote control.

In addition, when the remote control transmitter is used for the remote control, the remote control transmitter and a remote control receiver that receives a remote control signal from the remote control transmitter are necessary, which causes a substantial increase of cost. In contrast, with the sound recording device according to the first embodiment of the present invention, it is sufficient to add the detection unit 10 and the control unit 11, the substantial increase of cost can be avoided as another merit.

<Specific Sound Signal>

It is considered that the following signals can be used, for example, as the specific sound signal corresponding to the specific sound output from a predetermined instrument.

1. a sound signal consisting of one specific frequency component (e.g., a sound signal consisting of the 110 Hz component of open A string of a guitar)

2. a sound signal consisting of a plurality of specific frequency components (e.g., a sound signal consisting of the 110 Hz component of open A string of a guitar and the 146.8324 Hz component of open D string of a guitar)

3. a sound signal that consists of one specific frequency component and has a specific rhythm in a predetermined time (e.g., a sound signal having two 110 Hz components generated at an interval of one second in five seconds)

4. a sound signal that consists of a plurality of specific frequency components and has a specific rhythm in a predetermined time (e.g., a sound signal having a 110 Hz component and a 146.8324 Hz component generated at an interval of one second in eight seconds in the order of the 110 Hz component, the 146.8324 Hz component, and the 110 Hz component)

5. a sound signal containing at least one of a plurality of specific frequency components (e.g., a sound signal containing at least one of the 110 Hz component of open A string of a guitar and the 146.8324 Hz component of open D string of a guitar)

6. a sound signal that is one of the sound signals described above in 1 to 5, in which the specific frequency component have a certain range (e.g., a sound signal consisting of the 110 to 120 Hz component)

<Detection Method for Specific Frequency Component>

It is considered that the following methods can be used, for example, as the detection method for the specific frequency component described above.

1. a detection method for the specific frequency component using a band pass filter

2. a detection method for the specific frequency component using Fourier transform

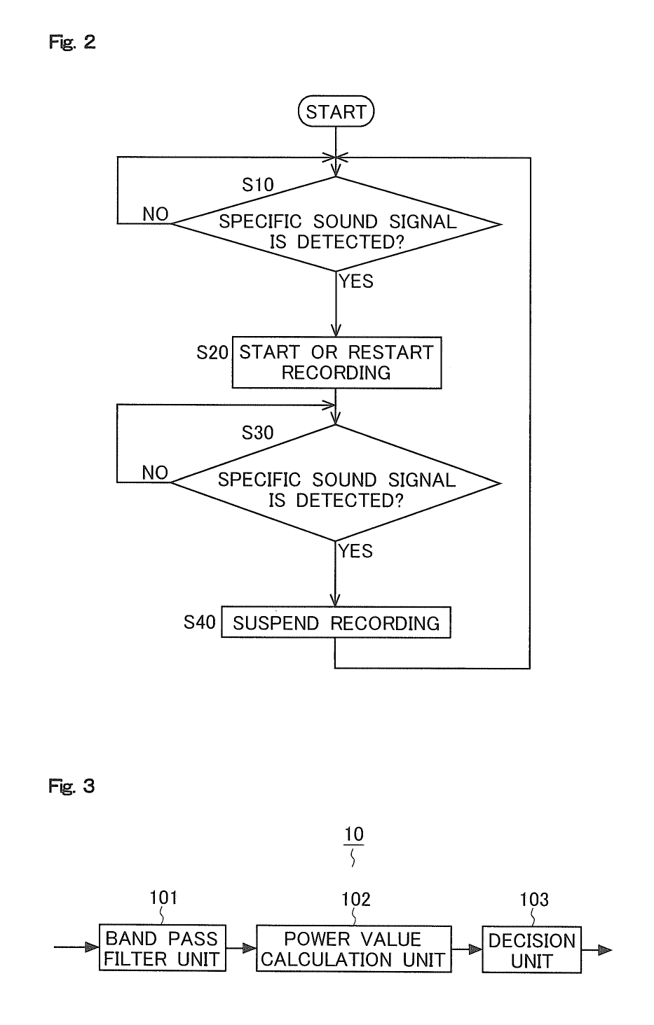

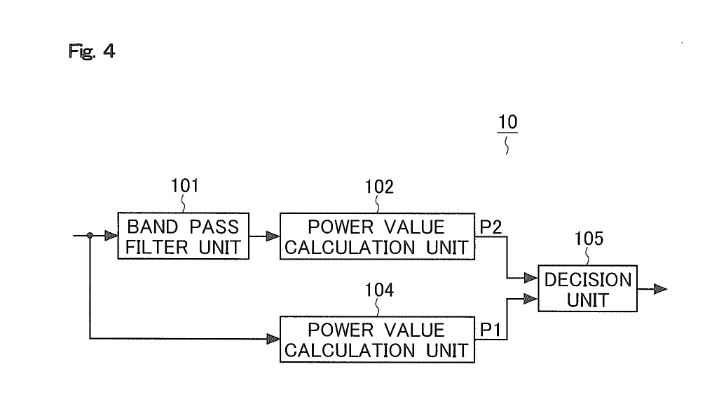

First, the detection method for the specific frequency component using a band pass filter will be described. When performing the detection method for the specific frequency component using a band pass filter, the detection unit 10 should have a structure illustrated in FIG. 3, for example. In the structural example illustrated in FIG. 3, the detection unit 10 includes a band pass filter unit 101, a power value calculation unit 102, and a decision unit 103.

The band pass filter unit 101 extracts only a specific frequency component from the digital sound signal output from the A/D converter unit 3 (see FIG. 1) and deliver the result to the power value calculation unit 102. The power value calculation unit 102 calculates a power value (average value of square of amplitude per unit time) of the sound signal (signal of the specific frequency component) after passing through the band pass filter unit 101, so as to deliver the calculated power value to the decision unit 103. The decision unit 103 compares the power value of the sound signal after passing through the band pass filter unit 101 with a predetermined threshold value. If the power value of the sound signal after passing through the band pass filter unit 101 is a predetermined threshold value or higher, the decision unit 103 decides that the specific frequency component is detected, and decides that the specific sound signal corresponding to the specific sound output from a predetermined instrument is detected. On the contrary, if the power value of the sound signal after passing through the band pass filter unit 101 is lower than the predetermined threshold value, the decision unit 103 decides that the specific frequency component is not detected, and decides that the specific sound signal corresponding to the specific sound output from a predetermined instrument is not detected.

In addition, when performing the detection method for the specific frequency component using a band pass filter, the detection unit 10 may have a structure as illustrated in FIG. 4. In the structural example illustrated in FIG. 4, the detection unit 10 includes the band pass filter unit 101 and power value calculation units 102 and 104, and a decision unit 105.

The band pass filter unit 101 extracts only the specific frequency component from the digital sound signal output from the A/D converter unit 3 and delivers the result to the power value calculation unit 102. The power value calculation unit 102 calculates a power value P2 of the sound signal after passing through the band pass filter unit 101, and delivers the calculated power value P2 to the decision unit 105. The power value calculation unit 104 calculates a power value P1 of the sound signal before passing through the band pass filter unit 101 (digital sound signal output from the A/D converter unit 3), and delivers the calculated power value P1 to the decision unit 105. The decision unit 105 divides the power value P2 output from the power value calculation unit 102 by the power value P1 output from the power value calculation unit 104, and compares the power value ratio P2/P1 obtained by the division with a predetermined threshold value. If the power value ratio P2/P1 is the predetermined threshold value or larger, the decision unit 105 decides that the specific frequency component is detected, and decides that the specific sound signal corresponding to the specific sound output from a predetermined instrument is detected. On the contrary, if the power value ratio P2/P1 is smaller than the predetermined threshold value, the decision unit 105 decides that the specific frequency component is not detected, and decides that the specific sound signal corresponding to the specific sound output from a predetermined instrument is not detected.

Further, it is possible to adopt a structure in which the decision unit 105 compares the power value P2 output from the power value calculation unit 102 with a predetermined first threshold value, divides the power value P2 output from the power value calculation unit 102 by the power value P1 output from the power value calculation unit 104, and compares the power value ratio P2/P1 obtained by the division with a predetermined second threshold value. In this case, if the power value ratio P2 is the predetermined first threshold value or larger, and if the power value ratio P2/P1 is a predetermined second threshold value or larger, the decision unit 105 decides that the specific frequency component is detected, and decides that the specific sound signal corresponding to the specific sound output from a predetermined instrument is detected. If the power value ratio P2 is smaller than the predetermined first threshold value, and/or if the power value ratio P2/P1 is smaller than the predetermined second threshold value, the decision unit 105 decides that the specific frequency component is not detected, and decides that the specific sound signal corresponding to the specific sound output from a predetermined instrument is not detected.

In the structural example illustrated in FIG. 4, it is possible to prevent that the specific sound signal corresponding to the specific sound output from a predetermined instrument is detected by mistake due to white noise.

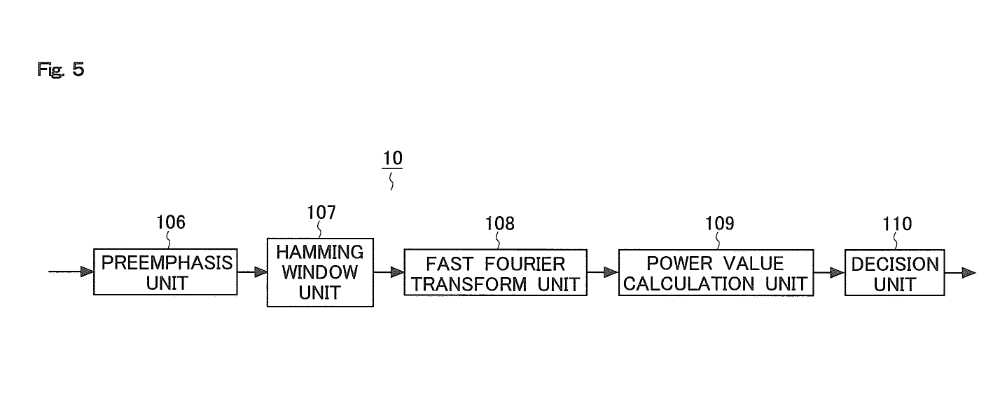

Next, the detection method for the specific frequency component using Fourier transform will be described. When performing the detection method for the specific frequency component using Fourier transform, the detection unit 10 should have a structure as illustrated in FIG. 5, for example. In the structural example illustrated in FIG. 5, the detection unit 10 includes a preemphasis unit 106, a hamming window unit 107, a fast Fourier transform unit 108, a power value calculation unit 109, and a decision unit 110.

The preemphasis unit 106 performs a spectrum flattening (preemphasis) process on the digital sound signal output from the A/D converter unit 3 (see FIG. 1), and delivers the result to the hamming window unit 107. The hamming window unit 107 performs a windowing process on the digital sound signal after the preemphasis process, and delivers the result to the fast Fourier transform unit 108. The fast Fourier transform unit 108 performs a fast Fourier transform process on the digital sound signal after the windowing process so as to convert the same into a digital sound signal in the frequency domain, and delivers the result to the power value calculation unit 109. The power value calculation unit 109 calculates a power value of the specific frequency component contained in the digital sound signal in the frequency domain (square values of a real part and an imaginary part of a spectrum of the specific frequency component), and delivers the calculated power value to the decision unit 110. The decision unit 110 compares the power value of the specific frequency component with a predetermined threshold value. If the power value of the specific frequency component is a predetermined threshold value or larger, the decision unit 110 decides that the specific frequency component is detected, and decides that the specific sound signal corresponding to the specific sound output from a predetermined instrument is detected. On the contrary, if the power value of the specific frequency component is smaller than the predetermined threshold value, the decision unit 110 decides that the specific frequency component is not detected, and decides that the specific sound signal corresponding to the specific sound output from a predetermined instrument is not detected.

Note that it is possible to adopt a structure in which the power value calculation unit 109 calculates a power value P3 of the specific frequency component contained in the digital sound signal in the frequency domain and a power value P4 of all frequency components contained in the digital sound signal in the frequency domain, and delivers the calculated power values P3 and P4 to the decision unit 110. In this case, it is considered that the decision unit 110 has two actions as follows, for example.

A first action of the decision unit 110 will be described. The decision unit 110 divides the power value P3 by the power value P4, and compares the power value ratio P3/P4 obtained by the division with a predetermined threshold value. If the power value ratio P3/P4 is the predetermined threshold value or larger, the decision unit 110 decides that the specific frequency component is detected, and decides that the specific sound signal corresponding to the specific sound output from a predetermined instrument is detected. On the contrary, if the power value ratio P3/P4 is smaller than the predetermined threshold value, the decision unit 110 decides that the specific frequency component is not detected, and decides that the specific sound signal corresponding to the specific sound output from a predetermined instrument is not detected.

Next, a second action of the decision unit 110 will be described. It is possible to adopt a structure in which the decision unit 110 compares the power value P3 with a predetermined first threshold value, divides the power value P3 by the power value P4, and compares the power value ratio P3/P4 obtained by the division with a predetermined second threshold value. If the power value P3 is the predetermined first threshold value or larger, and if the power value ratio P3/P4 is the predetermined second threshold value or larger, the decision unit 110 decides that the specific frequency component is detected, and decides that the specific sound signal corresponding to the specific sound output from a predetermined instrument is detected. On the contrary, if the power value P3 is smaller than the predetermined first threshold value, and/or if the power value ratio P3/P4 is smaller than the predetermined second threshold value, the decision unit 110 decides that the specific frequency component is not detected, and decides that the specific sound signal corresponding to the specific sound output from a predetermined instrument is not detected.

According to the structural example in which the decision unit 110 performs the decision on the basis of the power value ratio P3/P4 as described above, it is possible to prevent that the specific sound signal corresponding to the specific sound output from a predetermined instrument is detected by mistake due to white noise.

<Providing Information about Specific Sound Signal>

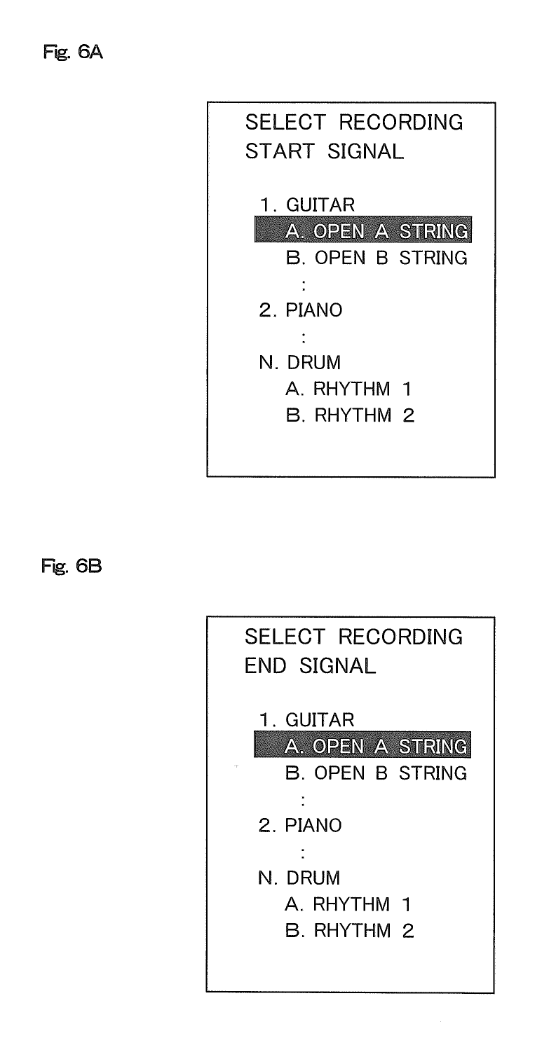

The sound recording device according to the first embodiment of the present invention is capable of providing information about specific sound signal. For instance, the specific sound signal that is currently set may be displayed in highlight like the display screen example on the display unit 13 as illustrated in FIGS. 6A and 6B, or the specific sound signal that is currently set may be informed to the user by another method. Further, it is desirable to adopt the following structure. The specific sound signal is stored in the IC memory 5 in advance. When the user performs a predetermined key operation using the operation unit 12, the specific sound signal that is currently set is read out from the IC memory 5 and is reproduced. Thus, the user can recognize which sound should be generated to perform the remote control.

In addition, it is possible to adopt the following structure. A plurality of specific sound signals are prepared and are displayed like the display screen example on the display unit 13 as illustrated in FIGS. 6A and 6B, for example. When the user presses an up/down key of the operation unit 12, the position of the highlight display is changed. When the user presses an enter key of the operation unit 12, the selected item with the highlight display is set as the specific sound signal, so that the specific sound signal can be changed.

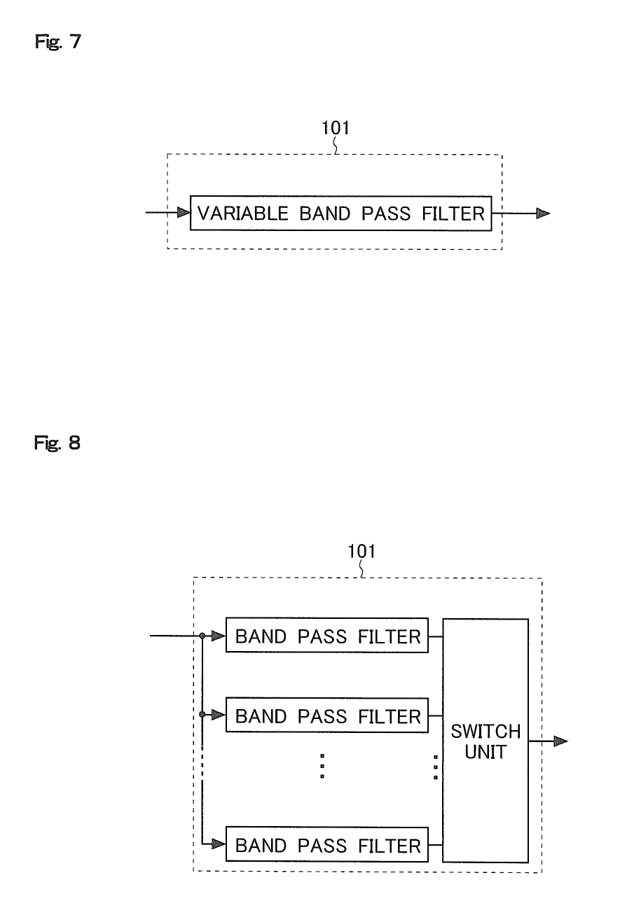

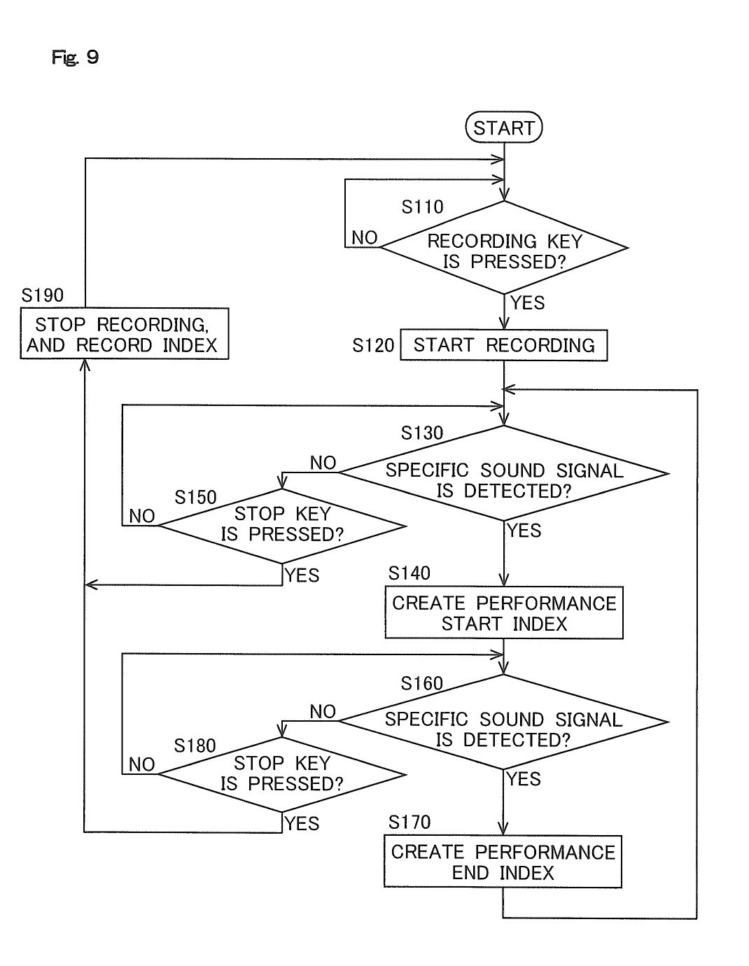

When a plurality of specific sound signals are prepared as described above, if the detection method for the specific frequency component using a band pass filter is adopted, in the structural example of the detection unit 10 illustrated in FIGS. 3 and 4, the band pass filter unit 101 may be a variable band pass filter as illustrated in FIG. 7, in which its pass band is variable. Alternatively, the band pass filter unit 101 may be constituted of a plurality of band pass filters having different pass bands and a switch unit for selecting at least one of the band pass filters as illustrated in FIG. 8.

In addition, when a plurality of specific sound signals are prepared as described above, if the detection method for the specific frequency component using Fourier transform is adopted, in the structural example of the detection unit 10 illustrated in FIG. 5, the power value calculation unit 109 should have a structure in which the specific frequency component can be changed.

### Second Embodiment

<Structure of Device>

A structure of the sound recording device according to a second embodiment of the present invention will be described. A block diagram of the sound recording device according to the second embodiment of the present invention is the same as the block diagram of the sound recording device according to the first embodiment of the present invention as illustrated in FIG. 1. However, actions of the record/reproduction unit 4 and the CPU 9 are different between the sound recording device according to the second embodiment of the present invention and the sound recording device according to the first embodiment of the present invention.

<Recording Action>

Next, the recording action of the sound recording device according to the second embodiment of the present invention in the case where the remote control mode based on a specific sound output from a predetermined instrument is set to ON will be described with reference to FIGS. 1 and 9. FIG. 9 is a flowchart illustrating the recording action of the sound recording device according to the second embodiment of the present invention in the case where the remote control mode based on a specific sound output from a predetermined instrument is set to ON. Note that the remote control mode based on a specific sound output from a predetermined instrument may be automatically set to ON when the sound recording device according to the second embodiment of the present invention is powered on by an operation of the user using the operation unit 12, or may be changed from OFF to ON by a predetermined key operation of the user using the operation unit 12.

First, the CPU 9 checks the operation signal output from the operation unit 12 so as to decide whether or not a recording key of the operation unit 12 is pressed (Step S110). If it is decided that the recording key is pressed (YES in Step S110), the process flow goes to Step S120.

In Step S120, the CPU 9 instructs the record/reproduction unit 4 to start recording, and then the process flow goes to Step S130.

In Step S130, the detection unit 10 tries to detect the specific sound signal corresponding to the specific sound output from a predetermined instrument.

When the detection unit 10 detects the specific sound signal corresponding to the specific sound output from a predetermined instrument (YES in Step S130), the control unit 11 creates a performance start index indicating a start position of the performance (Step S140), and then the process flow goes to Step S160. The performance start index includes record time when the performance starts, for example, so that the start position of the performance can be indicated. Note that it is possible to adopt a structure in which the control unit 11 creates the performance start index promptly when the detection unit 10 detects the specific sound signal corresponding to the specific sound output from a predetermined instrument. However, in order to avoid that the performance start index is before the specific sound signal, it is desirable that the control unit 11 creates the performance start index a predetermined time (e.g., five seconds) after the detection unit 10 detects the specific sound signal corresponding to the specific sound output from a predetermined instrument.

On the contrary, if the detection unit 10 does not detect the specific sound signal corresponding to the specific sound output from a predetermined instrument (NO in Step S130), the CPU 9 checks the operation signal output from the operation unit 12 so as to decide whether or not a stop key of the operation unit 12 is pressed (Step S150). If it is decided that the stop key is not pressed (NO in Step S150), the process goes back to Step S130. If it is decided that the stop key is pressed (YES in Step S150), the process flow goes to Step S190 that will be described later.

In Step S160, the detection unit 10 tries to detect the specific sound signal corresponding to the specific sound output from a predetermined instrument. Note that the specific sound signal to be detected in Step S160 may be the same as or different from the specific sound signal to be detected in Step S130.

When the detection unit 10 detects the specific sound signal corresponding to the specific sound output from a predetermined instrument (YES in Step S160), the control unit 11 creates a performance end index indicating an end position of the performance (Step S170), and then the process goes back to Step S130. The performance end index includes record time when the performance ends, for example, so that the end position of the performance can be indicated. Note that it is possible to adopt a structure in which the control unit 11 creates the performance end index promptly when the detection unit 10 detects the specific sound signal corresponding to the specific sound output from a predetermined instrument. However, in order to avoid that the performance end index is after the specific sound signal, it is desirable that a time point that is a predetermined time (e.g., five seconds) before the detection unit 10 detects the specific sound signal corresponding to the specific sound output from a predetermined instrument is set to the record time at the end of the performance.

On the contrary, if the detection unit 10 does not detect the specific sound signal corresponding to the specific sound output from a predetermined instrument (NO in Step S160), the CPU 9 checks the operation signal output from the operation unit 12 so as to decide whether or not the stop key of the operation unit 12 is pressed (Step S180). If it is decided that the stop key is not pressed (NO in Step S180), the process goes back to Step S160. If it is decided that the stop key is pressed (YES in Step S180), the process flow goes to Step S190.

In Step S190, the CPU 9 stops recording and sends the created performance start index and performance end index to the record/reproduction unit 4. Further, the CPU 9 controls the record/reproduction unit 4 so that the record/reproduction unit 4 records the performance start index and the performance end index in association with the recorded sound signal in the IC memory 5, and then the process goes back to Step S110.

In addition, if the remote control mode based on a specific sound output from a predetermined instrument is set to ON, it is preferable to inform the user that the remote control mode based on a specific sound output from a predetermined instrument is set to ON. As the informing method, for example, there is a method in which an LED lamp is provided to the sound recording device according to the second embodiment of the present invention, and the LED lamp is turned on when the remote control mode based on a specific sound output from a predetermined instrument is set to ON, while the LED lamp is turned off when the remote control mode based on a specific sound output from a predetermined instrument is set to OFF.

More desirably, when the remote control mode based on a specific sound output from a predetermined instrument is set to ON, it is preferable to inform the user whether or not the recording is being performed. As the informing method, for example, there is a method in which an LED lamp is provided to the sound recording device according to the second embodiment of the present invention, the LED lamp is blinked when the remote control mode based on a specific sound output from a predetermined instrument is set to ON and the recording is being performed, the LED lamp is turned on when the remote control mode based on a specific sound output from a predetermined instrument is set to ON and the recording is not being performed, and the LED lamp is turned off when the remote control mode based on a specific sound output from a predetermined instrument is set to OFF.

Still more desirably, it is preferable to inform the user whether or not it is during the period after the performance start index is created and before the performance end index is created, while the recording is performed in the state where the remote control mode based on a specific sound output from a predetermined instrument is set to ON. As the informing method, for example, there is the following method. An LED lamp is provided to the sound recording device according to the second embodiment of the present invention. The LED lamp is blinked at a first blinking interval if the recording is performed in the state where the remote control mode based on a specific sound output from a predetermined instrument is set to ON, and if it is during the period after the performance start index is created and before the performance end index is created. The LED lamp is blinked at a second blinking interval that is different from the first blinking interval if the recording is performed in the state where the remote control mode based on a specific sound output from a predetermined instrument is set to ON, and if it is not during the period after the performance start index is created and before the performance end index is created. The LED lamp is turned on if the remote control mode based on a specific sound output from a predetermined instrument is set to ON, and if the recording is not being performed. Further, the LED lamp is turned off if the remote control mode based on a specific sound output from a predetermined instrument is set to OFF.

With the recording action described above, the user can perform remote control of creation of the performance start index and the performance end index using a predetermined instrument. Therefore, when recording a practice performance of a band, for example, it is easy to find the performance start position in a reproducing process or to perform editing of the data.

When the remote control transmitter is used for remote control, it is necessary to hold the remote control transmitter in hand. Therefore, it is difficult to transfer smoothly from the remote control using the remote control transmitter to playing of the instrument, or to transfer smoothly from playing of the instrument to the remote control using the remote control transmitter. In contrast, with the sound recording device according to the second embodiment of the present invention, the remote control can be performed using a predetermined instrument. Therefore, there is a merit that it is possible to transfer smoothly from the remote control to the playing of the instrument, or to transfer smoothly from playing of the instrument to the remote control.

<Specific Sound Signal>

<Detection Method for Specific Frequency Component>

<Providing Information about Specific Sound Signal>

Being the same as the first embodiment, descriptions thereof are omitted.

<<Variations>>

Although the embodiments of the present invention are described above, the scope of the present invention is not limited to those, which can be modified in the scope of the present invention without deviating from the spirit thereof. Some examples of the modifications are described as follows.

The sound recording device according to the first or the second embodiment of the present invention includes the microphone 1 in it, but instead of or in addition to the microphone 1, it may have an external sound input terminal to which an external microphone or the like can be connected.

In addition, the sound recording device according to the first or the second embodiment of the present invention includes the speaker 8 in it, but instead of or in addition to the speaker 8, it may have an external sound output terminal to which an external speaker or the like can be connected.

In addition, the sound recording device according to the first or the second embodiment of the present invention includes the IC memory 5 in it, but instead of or in addition to the IC memory 5, it may have a memory mounting unit to which an external memory (e.g., an SD card) is mounted in a detachable manner. In addition, it is possible to adopt a structure in which the sound signal is recorded in a recording medium (e.g., an optical disc) other than the IC memory.

In addition, the sound recording device according to the first embodiment of the present invention suspends recording by remote control using a predetermined instrument, but instead, it is possible to adopt a structure in which the recording is suspended if the state where the power value of the digital sound signal output from the A/D converter unit 3 is lower than a predetermined value continues for a predetermined time. Similarly, the sound recording device according to the second embodiment of the present invention creates the performance end index by remote control using a predetermined instrument, but instead, it is possible to adopt a structure in which the performance end index is created if the state where the power value of the digital sound signal output from the A/D converter unit 3 is lower than a predetermined value continues for a predetermined time.

In addition, the sound recording device may be used not only for recording a music performance but also for recording a chorus or a solo vocal of a cappella. When a chorus or a solo vocal of a cappella is recorded by remote control, it is desirable to avoid an inconvenience that unnecessary parts before and after the chorus or the solo vocal (e.g., a conversation among the chorus members just before start of chorus) are recorded.

Therefore, it is possible to adopt the following structure in the sound recording device according to the first embodiment of the present invention. Each of Steps S10 and S30 in FIG. 2 is changed into a step of trying to detect the specific sound signal corresponding to the specific sound output from a predetermined instrument or the specific singing voice. If either the specific sound signal corresponding to the specific sound output from a predetermined instrument or the specific singing voice is not detected, the process flow stays on the step. Note that the specific sound signal to be detected in Step S30 after the change may be the same as or different from the specific sound signal to be detected in Step S10 after the change, and the specific singing voice to be detected in Step S30 after the change may be the same as or different from the specific singing voice to be detected in Step S10 after the change.

In addition, it is possible to adopt a structure in the sound recording device according to the second embodiment of the present invention. Each of Steps S130 and S160 illustrated in FIG. 9 is changed into a step of trying to detect the specific sound signal corresponding to the specific sound output from a predetermined instrument or the specific singing voice. If either the specific sound signal corresponding to the specific sound output from a predetermined instrument or the specific singing voice is not detected, the process flow goes to Step S150 or S180 illustrated in FIG. 9. Further, Step S140 illustrated in FIG. 9 is changed into a step in which the performance start index is created if the specific sound signal corresponding to the specific sound output from a predetermined instrument is detected in Step S130 after the change, while a singing voice start index is created if the specific singing voice is detected in Step S130 after the change. In addition, Step S170 illustrated in FIG. 9 is changed into a step in which the performance end index is created if the specific sound signal corresponding to the specific sound output from a predetermined instrument is detected in Step S160 after the change, while the singing voice end index is created if the specific singing voice is detected in Step S160 after the change. Note that the specific sound signal to be detected in Step S160 after the change may be the same as or different from the specific sound signal to be detected in Step S130 after the change, and the specific singing voice to be detected in Step S160 after the change may be the same as or different from the specific singing voice to be detected in Step S130 after the change.

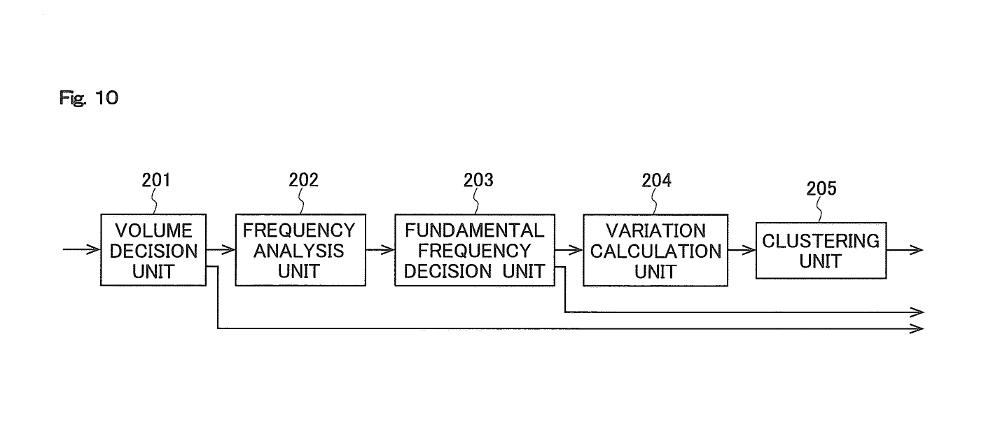

Hereinafter, an example of the singing voice detection unit that detects the specific singing voice will be described with reference to FIG. 10. The singing voice detection unit illustrated in FIG. 10 is disposed in the CPU 9 of the sound recording device according to the first embodiment of the present invention or the sound recording device according to the second embodiment of the present invention (see FIGS. 1 and 9).

The singing voice detection unit illustrated in FIG. 10 includes a volume decision unit 201, a frequency analysis unit 202, a fundamental frequency decision unit 203, a variation calculation unit 204, and a clustering unit 205.

The volume decision unit 201 decides whether or not the volume (power value) of the digital sound signal output from the A/D converter unit 3 (see FIG. 1) is a predetermined reference value or larger. If the volume is the reference value or larger, the digital sound signal output from the A/D converter unit 3 (see FIG. 1) is sent to the frequency analysis unit 202. If the volume is smaller than the reference value, the control unit 11 (see FIG. 1) is informed that the specific singing voice has not been detected.

The frequency analysis unit 202 converts the digital sound signal output from the A/D converter unit 3 (see FIG. 1) into a digital sound signal in the frequency domain so as to perform frequency analysis, and obtains fundamental frequency information (information indicating the height of the voice) of the digital sound signal output from the A/D converter unit 3 (see FIG. 1) and spectrum information (information indicating the tone) of the digital sound signal output from the A/D converter unit 3 (see FIG. 1), so as to send them to the fundamental frequency decision unit 203.

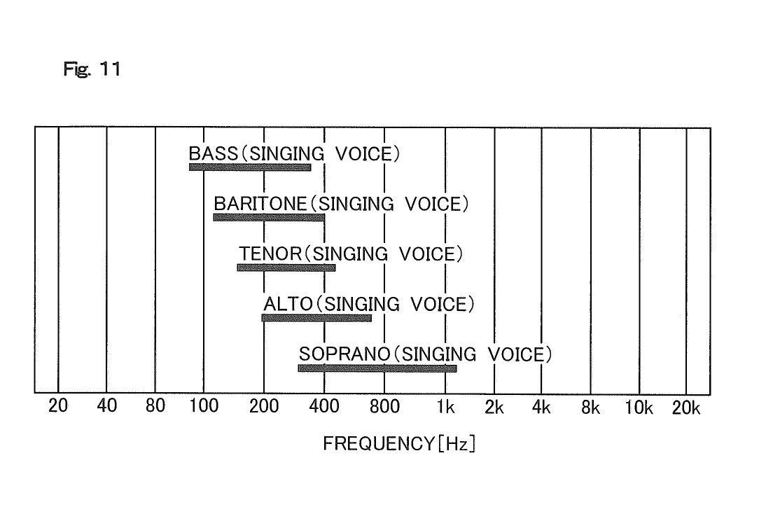

The fundamental frequency decision unit 203 decides whether or not the fundamental frequency information obtained by the frequency analysis unit 202 is included in the fundamental frequency band of the singing voice illustrated in FIG. 11. If the fundamental frequency information obtained by the frequency analysis unit 202 is included in the fundamental frequency band of the singing voice illustrated in FIG. 11, the fundamental frequency information and the spectrum information obtained by the frequency analysis unit 202 are sent to the variation calculation unit 204. On the contrary, if the fundamental frequency information obtained by the frequency analysis unit 202 is not included in the fundamental frequency band of the singing voice illustrated in FIG. 11, it is decided not to be singing voice. Then, the control unit 11 (see FIG. 1) is informed that the specific singing voice has not been detected.

The variation calculation unit 204 analyzes how much each of the fundamental frequency information and the spectrum information obtained by the frequency analysis unit 202 has changed in a predetermined time, and calculates a “fundamental frequency variation” and a “spectrum variation” indicating a cadence so as to send them to the clustering unit 205.

The clustering unit 205 performs clustering (grouping) of the digital sound signal output from the A/D converter unit 3 (see FIG. 1) into a “singing voice signal” or a “speech voice signal” using a “singing voice model” and a “speech voice model”. The “singing voice model” can be created by calculating the fundamental frequency information and spectrum information from various sample data (teaching data) of singing voices so as to model them. Similarly, the “speech voice model” can be created by calculating the fundamental frequency information and spectrum information from various sample data (teaching data) of speech voices so as to model them. It is preferable to store the created “singing voice model” and “speech voice model” in the IC memory 5 (see FIG. 1) in advance, so that the clustering unit 205 reads out the “singing voice model” and the “speech voice model” as necessary from the IC memory 5 (see FIG. 1).

For instance, a singing voice is apt to have a stretched sound so that the “fundamental frequency variation” has a “value close to zero” in many cases. In contrast, a speech voice is apt to have the height of voice decreasing gradually toward the end of sentence so that the “fundamental frequency variation” has a “negative value” in many cases. Therefore, in the clustering process performed by the clustering unit 205, for example, if the “fundamental frequency variation” has a “value close to zero”, it is assumed that there is a high probability that the digital sound signal output from the A/D converter unit 3 (see FIG. 1) is a “speech voice signal”. If the “fundamental frequency variation” has a “negative value”, it is assumed that there is a high probability that the digital sound signal output from the A/D converter unit 3 (see FIG. 1) is a “voice signal”. If the signal is clustered into a “singing voice signal”, it is also decided whether the signal is a “specific singing voice signal” or “other singing voice signal”. If a result of the decision is the “specific singing voice signal”, the clustering unit 205 informs the control unit 11 (see FIG. 1) that the specific singing voice is detected. Otherwise, the clustering unit 205 informs the control unit 11 (see FIG. 1) that the specific singing voice is not detected.

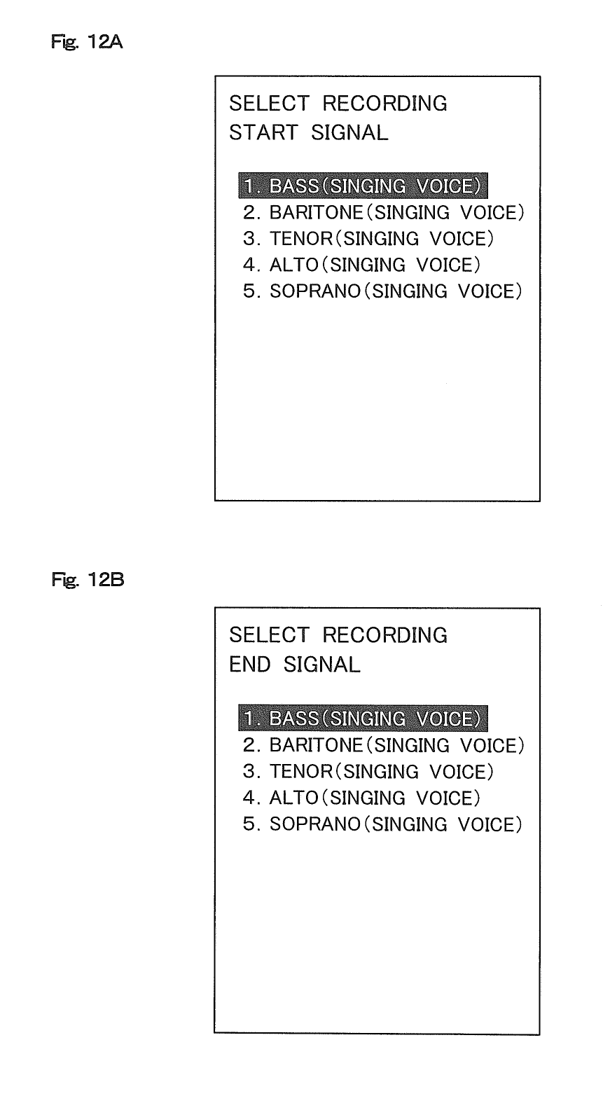

Note that it is desirable that information about the specific singing voice can be provided in the sound recording device in which the change of the step is performed as described above. For instance, like the display screen example of the display unit 13 illustrated in FIGS. 12A and 12B, the specific singing voice that is currently set may be displayed in highlight, or the specific singing voice that is currently set may be informed to the user by another method. Further, it is desirable to store the sample data of the specific singing voice in the IC memory 5 in advance, so that the sample data of the specific singing voice that is currently set is read out from the IC memory 5 and is reproduced when the user performs a predetermined key operation using the operation unit 12. Thus, the user can recognize real sound concerning height of singing voice that enables the remote control.

What is claimed is:

1. A sound recording device comprising:
a recording unit which records an input sound signal in a recording medium;
a detection unit which detects a specific sound signal corresponding to specific sound output from a predetermined instrument that can be included in the input sound signal; and
a control unit which controls an action of the recording unit on the basis of a result of the detection by the detection unit.

2. A sound recording device according to claim 1, wherein the control unit controls the recording unit to start or restart recording a predetermined time after the detection unit detects the specific sound signal, or creates a performance start index with a performance start position that is a predetermined time after the detection unit detects the specific sound signal.

3. A sound recording device according to claim 1, wherein the detection unit detects a specific frequency component of the input sound signal as the specific sound signal if the specific frequency component has a predetermined level or higher.

4. A sound recording device according to claim 1, wherein the detection unit detects a specific frequency component of the input sound signal as the specific sound signal if the specific frequency component occurs at a specific rhythm in a predetermined time.

5. A sound recording device according to claim 3, wherein the specific frequency component is a combination of a plurality of frequency components.

6. A sound recording device according to claim 4, wherein the specific frequency component is a combination of a plurality of frequency components.

7. A sound recording device according to claim 1, further comprising a display unit which displays information concerning the specific sound output from a predetermined instrument.

8. A sound recording device according to claim 1, further comprising a singing voice detection unit which detects a specific singing voice that can be contained in the input sound signal, wherein the control unit controls an action of the recording unit on the basis of a result of the detection by the detection unit and a result of the detection by the singing voice detection unit.

9. A sound recording device according to claim 7, further comprising a singing voice detection unit which detects a specific singing voice that can be contained in the input sound signal, wherein
the control unit controls an action of the recording unit on the basis of a result of the detection by the detection unit and a result of the detection by the singing voice detection unit, and
the display unit displays information about the specific sound output from a predetermined instrument and information about the specific singing voice.

10. A sound recording device according to claim 8, wherein the singing voice detection unit can change the specific singing voice.

11. A sound recording device according to claim 9, wherein the singing voice detection unit can change the specific singing voice.

12. A sound recording device according to claim 1, wherein the detection unit can change the specific sound signal.

13. A sound recording device according to claim 1, further comprising a reproduction unit which reproduces the specific sound signal.

14. A sound recording device according to claim 8, further comprising a reproduction unit which reproduces the specific singing voice.

15. A sound recording device according to claim 9, further comprising a reproduction unit which reproduces the specific singing voice.
